(19) United States
(12) Patent Application Publication
(10) Pub. No.: US 2011/0058913 A1
(43) Pub. Date: Mar. 10, 2011

(54) TOOL HEAD FOR USE IN A MULTIAXIS MACHINE, MULTIAXIS MACHINE HAVING SUCH A TOOL HEAD, AND USE OF SUCH A MACHINE

(75) Inventors: Christian Brieden, Huckeswagen (DE); Bernd Von der Mark, Radevormwald (DE)

(73) Assignee: Klingelnberg AG, Zurich (CH)

(21) Appl. No.: 12/873,665

(22) Filed: Sep. 1, 2010

(30) Foreign Application Priority Data
Sep. 10, 2009 (EP) 09169933.0

(51) Int. Cl. B23C 1/12; B23Q 5/04

(52) U.S. Cl. 409/211; 409/232; 409/230

(57) ABSTRACT

Tool head (110) for use in a multiaxis machine (100), the tool head (110) comprising a spindle body, which has two elements (101, 102). These elements (101, 102) are rotatably connected with one another via a corresponding coupling (103), the first element (101) having a first longitudinal axis (WA1) and the second element (102) having a second longitudinal axis (WA2), which are transferable from a stretched position into an angled position depending on the rotational position. A first drive (A1) is seated in or on the spindle body. A receptacle device (120) is provided, which is situated on the second element (102). This receptacle device (120) is used for fastening a motor spindle (20), a motor (M1), which is integrated in the motor spindle (20), being able to be supplied with power via the second element (102) and via electrical connection means of the receptacle device (120). The receptacle device (120) is also used for fastening a milling tool (30), which is drivable using the first drive (A1).

### CROSS REFERENCE TO RELATED APPLICATION

The present application claims the priority of European Patent Application No. 09169933.0, which was filed on 10 Sep. 2009 and is incorporated herein by reference.

### FIELD OF THE INVENTION

The object of the invention is a tool head for use in a multiaxis machine, a multiaxis machine having such a tool head, and the use of such a machine.

### BACKGROUND OF THE INVENTION

### Prior Art

There is an entire array of specialized machines, which are designed and optimized for the processing of greatly varying materials and workpieces. The costs of such specialized machines are frequently relatively high. It is sometimes viewed as a disadvantage of these specialized machines that their capacity can only be ensured if large piece counts of identical or similar workpieces are to be processed.

There is an increasingly a demand to improve the capacity of the corresponding machines in that the machines are made more flexibly usable by add-ons or alterations. It can occur that the add-ons or alterations obstruct the actual use of the machine in the original specialized area, or the reliability or precision of the machine is impaired.

The object of the present invention is therefore to design a processing machine so that it is usable, on the one hand, as a gear cutting machine for manufacturing bevel gears, for example, but it can also be used for other processing methods or situations.

The object of the present invention is also to provide a tool head, which is flexibly and universally usable as part of a processing machine.

### SUMMARY OF THE INVENTION

This object is achieved according to the present invention by a tool head, which is specially designed for use in a multiaxis machine. The tool head comprises a spindle body, which has two elements or assemblies, which are rotatably connected to one another via a corresponding coupling. The configuration is such that the first element of the two elements has a first longitudinal axis and the second element of the two elements has a second longitudinal axis, which are transferable depending on the rotational position from a concentric (stretched) position into an angled position. A first (main) drive is seated in or on the spindle body. A receptacle device is provided, which is situated on the second element. This receptacle device is designed for temporarily fastening a motor spindle, a motor, which is integrated in the motor spindle, being able to be supplied with energy (e.g., electrical power in the form of current) via the second element and connection means (e.g., electrical connection means) of the receptacle device. In addition, the receptacle device is designed for temporarily fastening a milling tool, the milling tool being drivable using the first drive.

The devices according to the invention are especially designed for the manufacturing of gearwheels and/or the processing of tooth flanks. The tools which are used are to be selected accordingly.

The most important advantage of the invention is seen in that a corresponding specialized machine equipped with the tool head according to the invention is more flexibly usable. In spite of the corresponding structural changes of the machine, the precision properties are not negatively impaired.

### BRIEF DESCRIPTION OF THE DRAWINGS

Further details and advantages of the invention are described hereafter on the basis of exemplary embodiments and with reference to the drawing. In the figures:

FIG. 1A shows a schematic side view of a first tool head according to the invention in a stretched position;

FIG. 1B shows a schematic side view of the first tool head according to the invention from FIG. 1A in an angled position;

FIG. 2 shows a schematic perspective view of a further tool head according to the invention in a stretched position;

FIG. 3A shows a schematic side view of a machine according to the invention having tool head in a stretched position, the tool head carrying a motor spindle having milling cutter;

FIG. 3B shows a schematic side view of the machine according to the invention having tool head from FIG. 3A in an angled position, the tool head carrying a motor spindle having milling cutter;

FIG. 3C shows a schematic side view of a motor spindle having milling cutter;

FIG. 4A shows a schematic side view of a machine according to the invention having tool head in a stretched position, the tool head carrying a milling tool;

FIG. 4B shows a schematic side view of the machine according to the invention having tool head from FIG. 4A in an angled position, the tool head carrying a milling tool;

FIG. 4C shows a schematic side view of a milling tool;

FIG. 5 shows a schematic side view of a further machine according to the invention having tool head in an angled position;

FIG. 6 shows a schematic side view of a further machine according to the invention having tool head in a stretched position, the tool head carrying a motor spindle having milling cutter;

FIG. 7 shows a schematic side view of a further machine according to the invention having tool head in a stretched position, the tool head carrying a motor spindle having milling cutter;

FIG. 8A shows a sectional view of a further tool head according to the invention in an angled position, the tool head carrying a milling tool;

FIG. 8B shows a sectional view of the tool head from FIG. 8A in an angled position, the tool head carrying a motor spindle having milling cutter;

FIG. 9 shows a sectional view of a further tool head according to the invention in an angled position, the tool head carrying a flange;

FIG. 10A shows a sectional view of a further tool head according to the invention, the tool head carrying a milling tool;

FIG. 10B shows a sectional view of the tool head from FIG. 10A, the tool head carrying a motor spindle;

FIG. 10C shows a sectional view of the tool head from FIG. 10A, the tool head carrying a flange.

### DESCRIPTION OF THE PREFERRED EMBODIMENTS

Terms are used in connection with the present description which are also used in relevant publications and patents. However, it is to be noted that the use of these terms is only to serve for better understanding. The ideas according to the invention and the protective scope of the patent claims are not to be restricted in their extent by the specific selection of the terms. The invention may be readily transferred to other term systems and/or technical fields. The terms are to be applied accordingly in other technical fields.

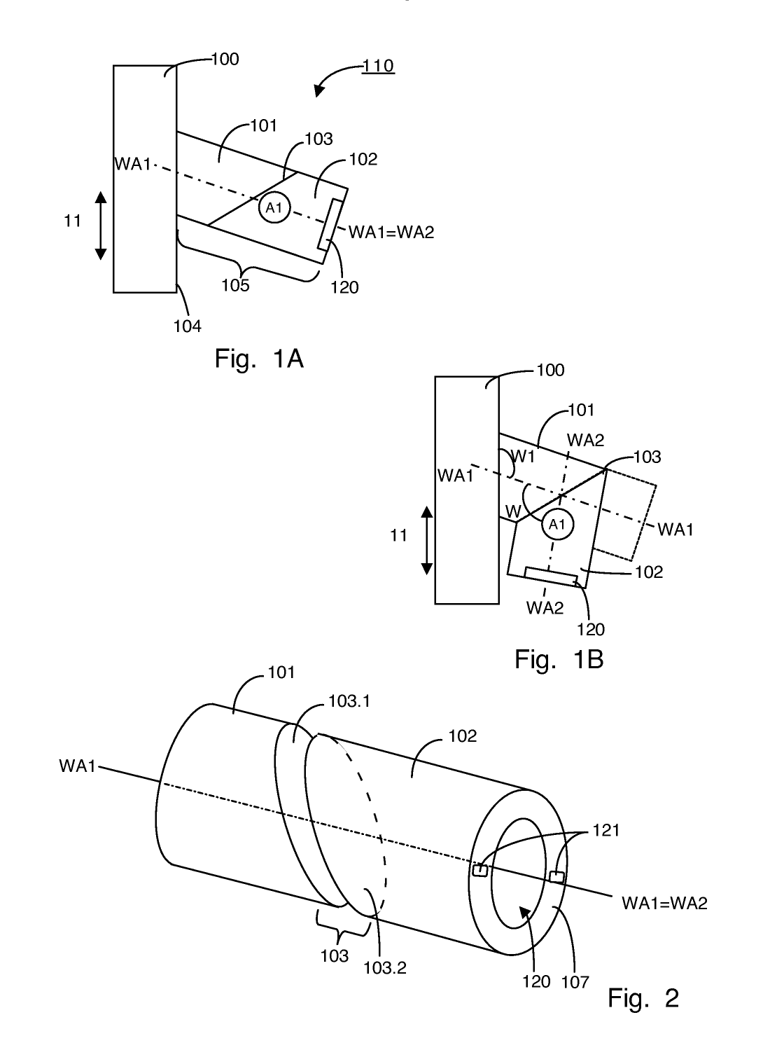

The invention relates to a novel tool head 110, which is shown in two extreme positions in FIGS. 1A and 1B. The tool head 110 is especially designed for use in a multiaxis machine 100. The machine 100, which is preferably a multiaxis, NC-controlled machine, is only shown as a block element in FIGS. 1A to 9.

The tool head 110 comprises a spindle body 105, which has two elements or assemblies 101, 102, as schematically indicated in FIGS. 1A and 1B. The two elements 101 and 102 are rotatably connected to one another via a corresponding coupling 103. The first element 101 has a first longitudinal axis WA1 (also referred to as the first tool axis) and the second element has a second longitudinal axis WA2 (also referred to as the second tool axis). The two elements 101, 102 are mechanically connected to one another by the coupling 103 in such a manner that they are transferable depending on the rotational position from a concentric position (also referred to as the stretched position) to an angled position. The stretched position, in which the longitudinal axes WA1 and WA2 are concentric to one another, is shown in FIG. 1A. The angled position, in which the longitudinal axis WA1 is angled to the longitudinal axis WA2, is shown in FIG. 1B. The angle W between the two longitudinal axes WA1, WA2 is somewhat greater than 90° in the example shown here.

Furthermore, the tool head 110 comprises a first drive A1 (also referred to as the main drive), which is seated in or on the spindle body 105. The first drive A1 drives the so-called main axis. This first drive A1 is preferably seated in the second element 102, as shown in FIGS. 1A, 1B, 3A, 3B, 4A, 4B, 8A, 8B, and 9.

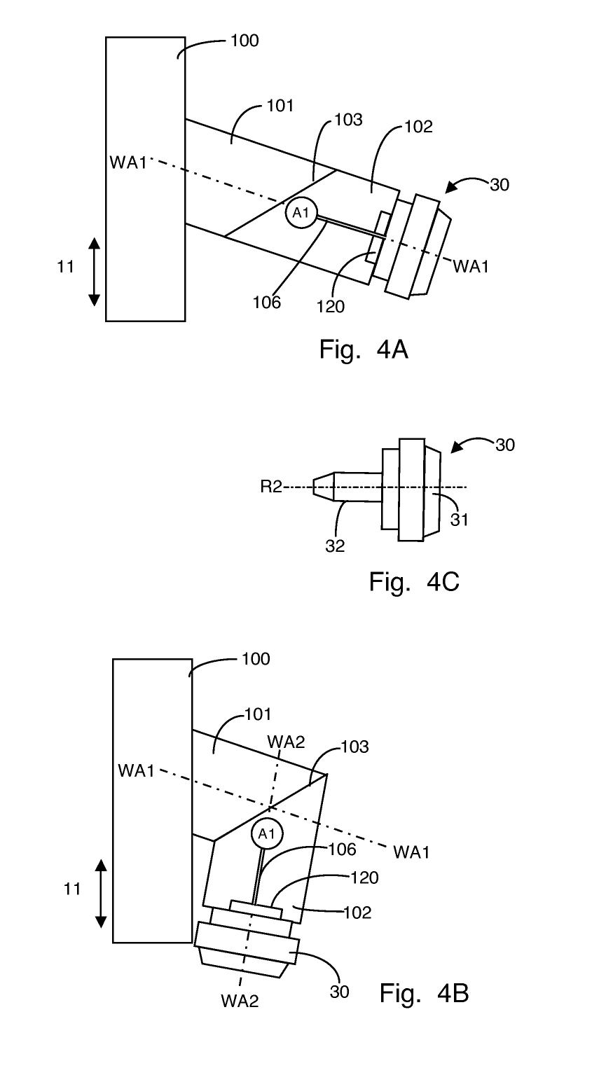

In addition, a receptacle device 120 (such as a clamping device) is provided, which is situated on the second element 102. The receptacle device 120 is shown in purely schematic form in the figures. It is designed for the mechanical fastening of a motor spindle 20, as shown in FIGS. 3A and 3B. A motor M1 is integrated in this motor spindle 20, in order to set a tool 21 (such as a milling cutter 21) into a rotational movement around a so-called auxiliary axis R1. The motor M1 of the motor spindle 20 can be supplied with energy (e.g., with electrical energy) and/or activated by an NC-controller 200 via the second element 102 and via connection means (e.g., electrical connection means) of the receptacle device 120. The drive A1 has two operating modes according to the invention:

1. The drive A1 is used as a drive of a tool, such as a frontal cutter head 30 for bevel gear milling. In this case, it is operated using high torque, relatively “low” speeds, and low dynamic response (speed and rotational direction change).

2. The drive A1 is used as a positioning drive (similarly to a “normal” CNC axis), e.g., to move the motor spindle 20. This is performed using high dynamic response.

The drive A1 is shown inverted in FIGS. 3A and 3B (white script on black background), in order to graphically indicate that this drive A1 is not used in the situation shown for driving a tool (e.g., the tool 30), but rather the drive A1 is used as a positioning drive.

Furthermore, the receptacle device 120 is designed so that alternatively also a milling tool 30 (preferably a cutter head) can be mechanically fastened. This milling tool 30 is drivable using the first drive A1. I.e., the receptacle device 120 not only ensures a fixed mechanical connection to the milling tool 30, but rather it also allows the drive coupling of the milling tool 30 to the first drive A1.

The novel tool head 110 is shown in FIG. 1A in the concentric position (first extreme position) and in FIG. 1B in the angled position (second extreme position). There are numerous intermediate positions between these two positions, which are generated by twisting/pivoting the element 102 in relation to the element 101. In both extreme positions, the tool axes WA1 and WA2 lie in a common plane. This common plane corresponds to the plane of the drawing in FIGS. 1A and 1B. In contrast, the tool axis WA2 is moved out of the plane in the intermediate positions.

A machine 100 in which the tool axis WA1 is seated inclined slightly downward on a vertical surface 104 of the machine 100 (see FIG. 1A) or on a differently oriented lateral surface of the machine 100 is particularly preferred. The angle of inclination W1 (see FIG. 1B) is preferably between 91 and 135° here.

The coupling 103 is preferably designed in the form of a connection like a universal joint, in order to allow the (continuous) pivoting and adjustment of the element 102 in relation to the element 101.

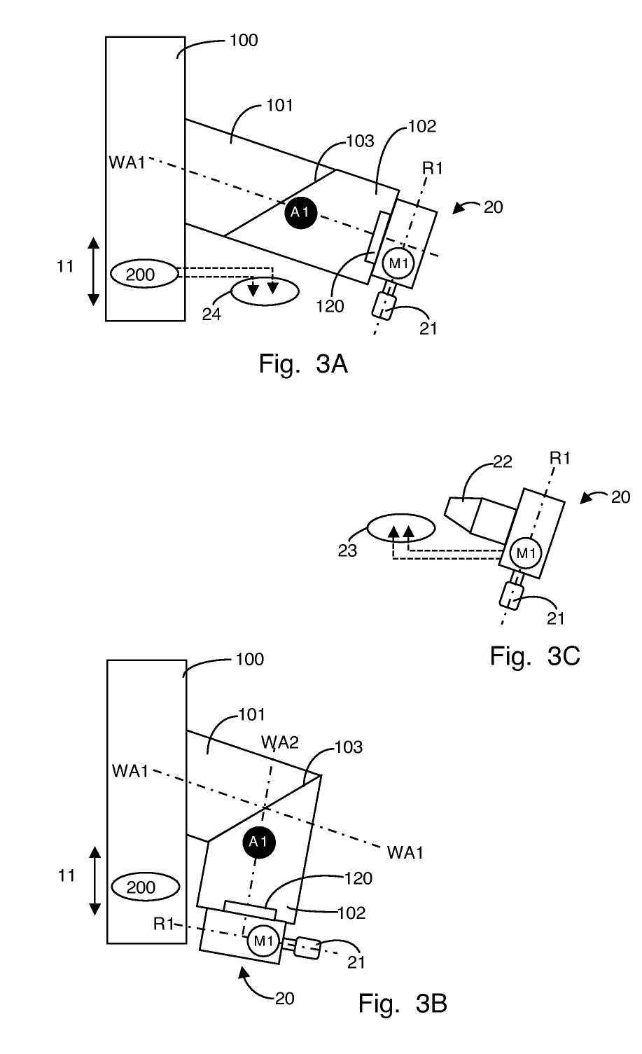

A tool head 110 whose coupling 103 is implemented using two inclined surfaces 103.1, 103.2, which are continuously pivotable in relation to one another, is particularly preferred. The fundamental principle of such a coupling 103 is shown in a perspective view in FIG. 2. The first element 101 has a round cross-section (in frontal section) and a diagonal terminal surface (diagonal surface) 103.1 in this exemplary embodiment. This diagonal surface 103.1 is oval in this exemplary embodiment. The second element 102 also has a round cross-section (in frontal cross-section) and a diagonal terminal surface (diagonal surface) 103.2. This diagonal surface 103.2 is also oval. The two elements 101, 102 are shown in the concentric (stretched) position in FIG. 2 and the tool axis WA2 is coincident with the tool axis WA1 (therefore, WA1=WA2).

If the element 102 was pivoted in relation to the element 101 in FIG. 2 until the other extreme position was reached, the tool axis WA2 would point diagonally upward.

Furthermore, it is indicated in FIG. 2 that, for example, a spindle seat in the form of a concentric (cylindrical or conically tapering) receptacle opening can be used as the receptacle device 120. The opening and closing of the receptacle device 120 can be performed manually, electrically, pneumatically, or hydraulically. The details of such receptacle device is 120 are well known and will therefore not be described further here. Clamping devices which are known from the field of gear-cutting machines are particularly suitable.

Connection means 121, via which a control connection to an NC-controller 200 of the machine 100 is producible, or which are used for the power supply of the motor M1, may also be situated on the receptacle device 120 or in the area of the receptacle device 120. It is schematically shown in FIG. 2 that two contact surfaces may be attached on the front side 107 of the second element 102, for example. Upon fastening of the motor spindle 20, contact pins or elements (e.g., the power terminals 23 in FIG. 3C) of the motor spindle 20 form an electrical connection with these contact surfaces 121. Depending on the embodiment, pneumatic and/or hydraulic connection means may also be provided in the area of the receptacle device 120.

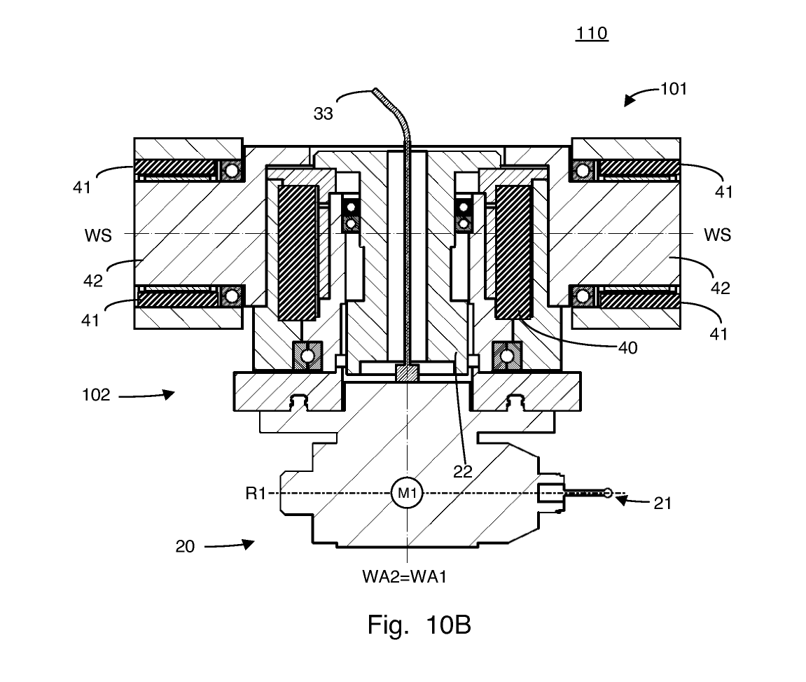

In all embodiments, the receptacle device 120 is designed so that it can receive and mechanically fix either the motor spindle 20 (e.g., equipped with a milling cutter 21) or the milling tool 30. The receptacle device 120 can also receive a flange 50 according to FIG. 9, for example. If the self-drivable motor spindle 20 is used, the receptacle device 120 must also ensure an electrical and/or pneumatic and/or hydraulic connection of the motor M1 to the machine 100. The (electrical) connection means 121 are provided for this purpose. The (electrical) connection means 121 are designed so that upon fastening of the motor spindle 20 on the second element 102, for example, an electrical connection is produced manually or automatically. The manual connection can be performed by bringing together plug contacts, for example. An automatic connection can be implemented using contact pins or elements and corresponding contact surfaces 121, for example.

When the milling tool 30 is used, the receptacle device 120 must ensure a drive connection of the drive A1 to the milling tool 30. The drive connection can be performed mechanically (for example, employing a shaft or a gearing). However, it is also possible to provide a hydraulic or pneumatic drive connection.

In FIGS. 3A and 3B, a corresponding tool head 110 is shown equipped with the self-drivable motor spindle 20. The self-drivable motor spindle 20 is inserted using a shaft 22 into a receptacle opening of the receptacle device 120 and chucked there using a clamping device. This shaft 22 runs coaxially to the tool axis WA2 in the chucked state. Details of a self-drivable motor spindle 20 are indicated in FIG. 3C. The power terminals 23 of the motor M1 are shown in FIG. 3C by two dashed arrows. The corresponding machine-side power terminals 23 are shown in FIG. 3A by two dashed arrows. Hydraulic and/or pneumatic connections may also be used instead of the power terminals 23.

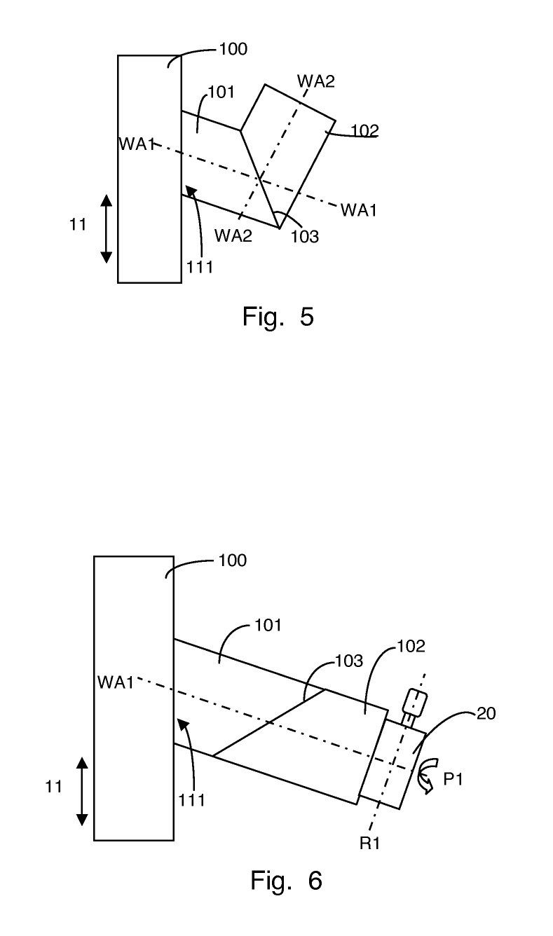

A corresponding tool head 110 is shown equipped with a milling tool 30 (in the form of a cutter head here), which is driven on the machine side, in FIGS. 4A and 4B. The milling tool 30 is inserted using a spindle or shaft 32 into a receptacle opening of the receptacle device 120 and chucked there using a clamping device. This shaft 32 runs coaxially to the tool axis WA2 in the chucked state. Details of a milling tool 30 in the form of a cutter head are indicated in FIG. 4C. Power terminals are not required here, because the milling tool 30 is driven directly by the drive A1. The corresponding drive connection 106 is indicated in FIGS. 4A and 4B by a double line, which extends between the drive A1 and the milling tool 30.

The constellation is shown in the stretched configuration in FIG. 4A and in the angle configuration in FIG. 4B. The tool or processing side is identified by 31 in FIG. 4C. Cutting edges or grinding surfaces may be located here, for example, or bar cutters may be used on the front side of the milling tool 30.

An NC-controlled multiaxis machine is preferably used as the machine 100. The controller 200 of the machine 100 and the constellation of the tool axes allows great flexibility, which is required by the adjustability of the axes and usability of the tools 20, 30. The elements 101, 102 may be adjusted horizontally and/or vertically and/or laterally by adjustment movements 11 of one or more slides or carriages, for example. In addition, the angle of the axes WA1 and WA2 to one another can be adjusted by pivoting the element 102 in relation to the element 101.

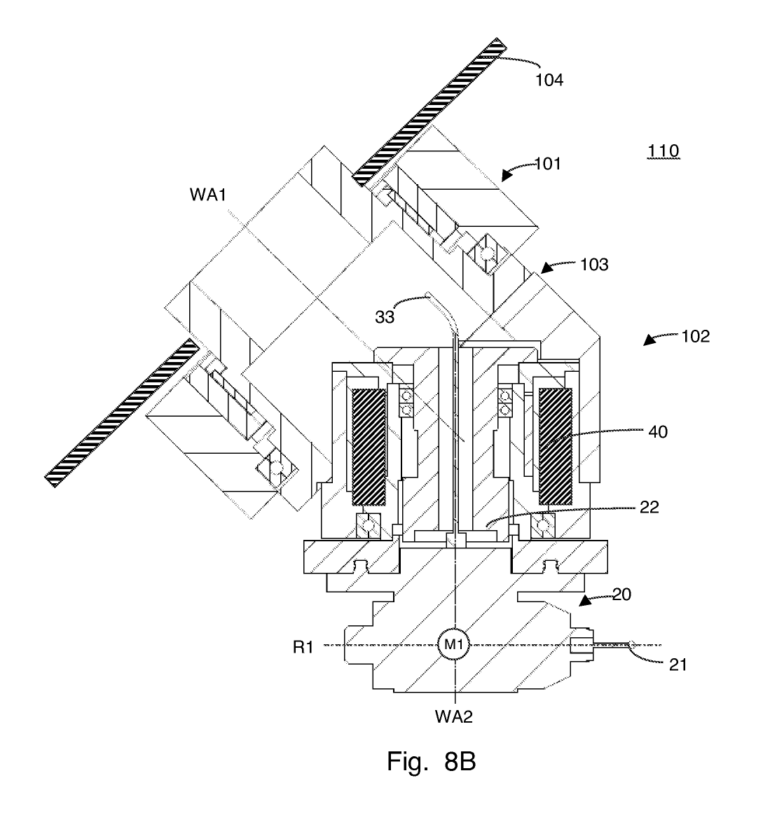

Optionally, the self-drivable motor spindle 20 can be rotated around the shaft 22, as indicated in FIG. 6 by the arrow P1. The drive A1 (not shown in FIG. 6) is used in this case as a positioning drive (similarly to a “normal” CNC axis) in order to move the motor spindle 20. This is preferably performed with high dynamic response.

Finally, the tool 21 (such as an end milling cutter) completes a rotational movement around the auxiliary axis R1. The milling tool 30, in contrast, completes a rotational movement around the tool axis WA2, which runs coaxially to the rotational axis R2 of the shaft 32 (see FIG. 4C).

The torque demand around the tool axis WA2 in the equipment with the self-drivable motor spindle 20 is less than in the direct equipment with the milling tool 30. Therefore, a lesser torque is sufficient in the second case than in the first case.

The self-drivable motor spindle 20 is flexibly usable and can be used, for example, for reworking a workpiece. The productivity of the tool 21 of the self-drivable motor spindle 20 is less than that of the milling tool 30. In contrast, if the milling tool 30 is used, the machine 100 can be used as a gear-cutting machine having greater productivity.

Milling refers here to the chip-removing processing of metals. According to the invention, for example, a cylindrical milling cutter 21 can be used as the tool (see FIG. 3A, for example), which is especially designed for the chip-removing processing of hardened metals. The milling cutter 21 can be a milling cutter which is used for grinding, or it can be a milling cutter which has cutting edges or blades in order to remove chips.

The milling tool 30, in contrast, can be equipped with a bar cutter set (for example, as a frontal cutter head). The individual bar cutters of the bar cutter set have cutting edges which are used for chip-removing processing.

The processing movement which is required for chip generation or removal is generated by rotation of the tool 21 (for example, in relation to a pre-finished tooth flank) around the auxiliary axis R1 or by rotation of the milling tool 30 around the rotational axis R2 (=WA2). The feed movement required for the shaping is generated by relative movement of the tools 20 or 30 in relation to the workpiece. The corresponding movements may be caused by the NC-controller 200 of a multiaxis machine 100. Rotating processing is also conceivable, in which the tool is fixed and the workpiece rotates.

The tool 21 and/or the milling tool 30 may be used running in the same direction or in the opposite direction as the workpiece.

According to the invention, a rotationally driven, cylindrical milling cutter 21 is preferably used as part of the self-drivable motor spindle 20. The auxiliary axis R1, as shown in FIGS. 3A and 3B, is used here as the rotational axis

The motor M1, which is integrated in the motor spindle 20, is used as the drive for the milling cutter 21. It is therefore an autonomous, i.e., self-drivable spindle 20, as already expressed by the designation motor spindle.

The milling tool 30 is designated, in contrast thereto, as a tool driven by the machine, because its drive A1 is seated on the machine side in the element 101, 102 or in the machine 100.

In summary, it can be stated that a tool axis WA2 on a machine 100 according to the invention is used once as a drive spindle having high torque demand and a rotational direction for operating a cutter head 30, for example, for milling bevel gears, and once as a positioning and movement axis, but with variable velocities or directions for an auxiliary spindle (called motor spindle 20 here). This motor spindle 20 carries the tool 21 and forms an autonomously drivable and flexibly usable tool together therewith.

The effectively active tool axis is implemented as “multiaxial” (i.e., composed of multiple partial axes WA1 and WA2) in this case, and is movable or settable in relation to the workpiece. The effectively active tool axis is composed here of the two tool axes WA1 and WA2, which stand in relation to one another in a specialized manner and are adjustable to one another. The adjustment of the tool axes WA1, WA2 can be performed continuously.

A corresponding controller (preferably an NC-controller 200) is provided for coupling the axial movements. The particular tool 20, 30 can thus be guided along programmed movement paths.

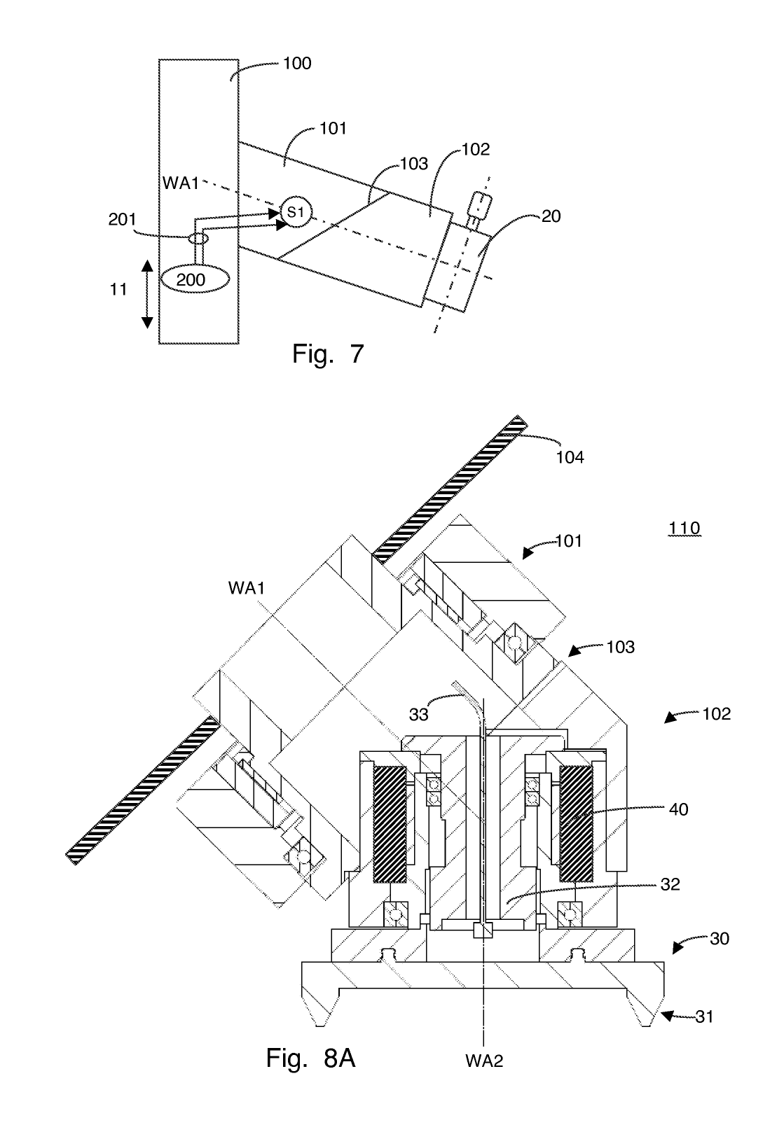

In a further preferred embodiment, the entire tool head 110 is fastened so it is rotatable in the transition area 111 between tool head 110 and machine 100. I.e., the tool head 100 can be pivoted around the tool axis WA1 in relation to the machine 100. Positions in which the second element 102 points upward, as indicated in FIG. 5, are thus also settable, for example.

Through such rotation in the area 111, as indicated in FIG. 6, the motor spindle 20 with milling cutter 21 can be rotated around the tool axis WA1=WA2 in the stretched position of the elements 101, 102. This rotational movement is shown by the arrow P1.

In another embodiment, a pivot capability is provided in the area of the receptacle device 120 or on the shaft 22 of the motor spindle 20.

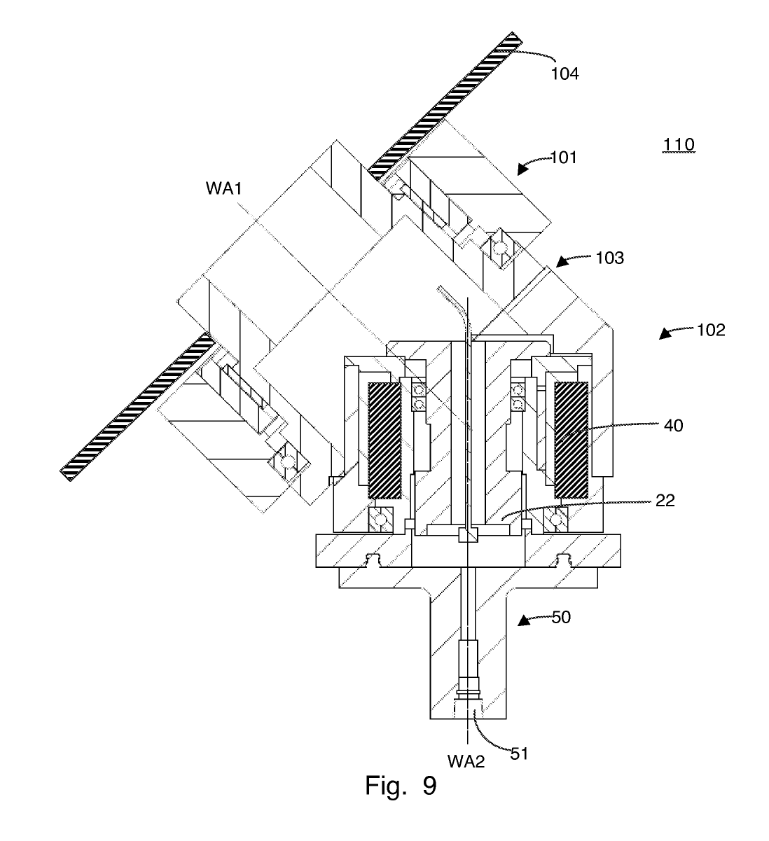

In a particularly preferred embodiment, a positioning drive S1 is provided in or on the tool head 110, as indicated in FIG. 7. This positioning drive S1 of the tool head 110 is activatable from the machine 100 (indicated in FIG. 7 by two arrows 201, which originate from the NC-controller 200), so that using a positioning movement, the second element 102 can be set into a desired angular position (rotated/tilted/pivoted) in relation to the first element 101. The automatic adjustability which is made possible by such a positioning drive S1 allows the machine 100 to be incorporated in automatic processing sequences. The positioning movement can either be performed before processing of a workpiece or continuously during the processing.

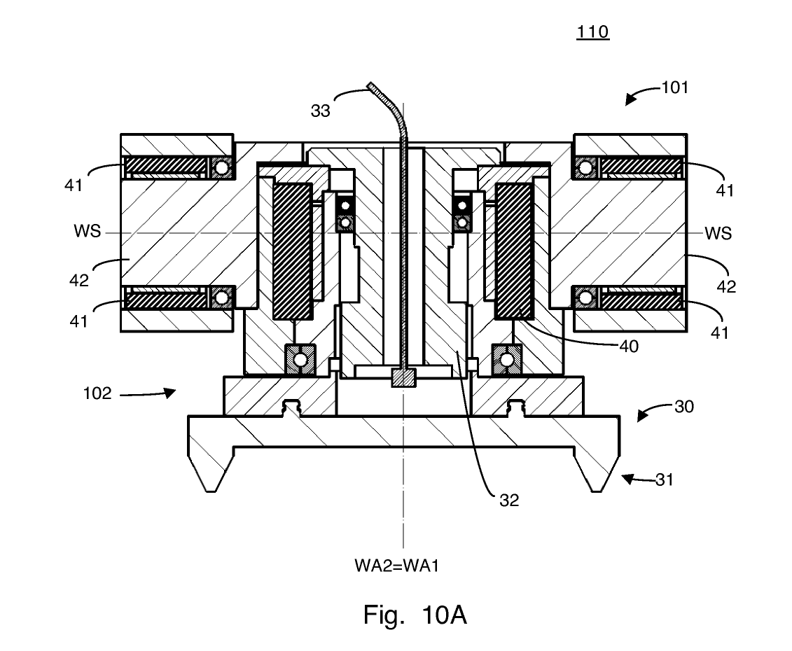

Details of a further embodiment are shown in FIGS. 8A and 8B. In FIG. 8A, the tool head 110 is equipped with a milling tool 30, whose shaft 32 extends into the interior of the second element 102. In FIG. 8A, details of the corresponding receptacle device 120 may be seen, without being discussed in greater detail here. An energy supply 33 and a coupling mechanism for the motor spindle 20 to be flanged on, for example, are contained inside the shaft 32. For example, the windings 40 of the drive A1 may be situated in the area of the second element 102. The drive A1 can also (if it is not situated directly in the area of the shaft 32) be seated in the coupling area 103 or even in the first element 101 or in the machine 100. Depending on the position of the drive A1, it can be connected to drive the milling tool 30 using a rigid shaft (e.g., shaft 106 in FIG. 4A) and/or a gearing or using a flexible shaft and/or a propeller shaft.

A constellation is shown in FIG. 8A in which the lateral surface 104 of the machine 100 is inclined. The milling tool 30 can thus, in a hanging position (as shown in FIG. 8A), process a workpiece, for example, which rests flatly on a table below the tool head 110.

In FIG. 8B, the tool head 110 is equipped with a motor spindle 20 including milling cutter 21. The energy supply 33 of the motor spindle 20 extends into the interior of the second element 102. Details of the corresponding receptacle device 120 may be recognized in FIG. 8B, without being discussed in greater detail here. The auxiliary axis R1 is perpendicular to the tool axis WA2, but can also be situated at another angle. Depending on the embodiment, the motor spindle 20 can be rotated around the tool axis WA2 or the tool head 110 can be rotated around the tool axis WA1, as already described. The drive A1 can be used during the processing of a workpiece when the motor spindle 20 is used, the drive A1 then being used as a positioning drive. Optionally, the drive A1 can be used to rotate the motor spindle 20 around the tool axis WA2, however.

A further embodiment is shown in FIG. 9. The elements are essentially the same again and are therefore not described once again. However, a flange 50 was used here. This flange 50 comprises a central hole 51 for receiving a tool (e.g., a drilling tool).

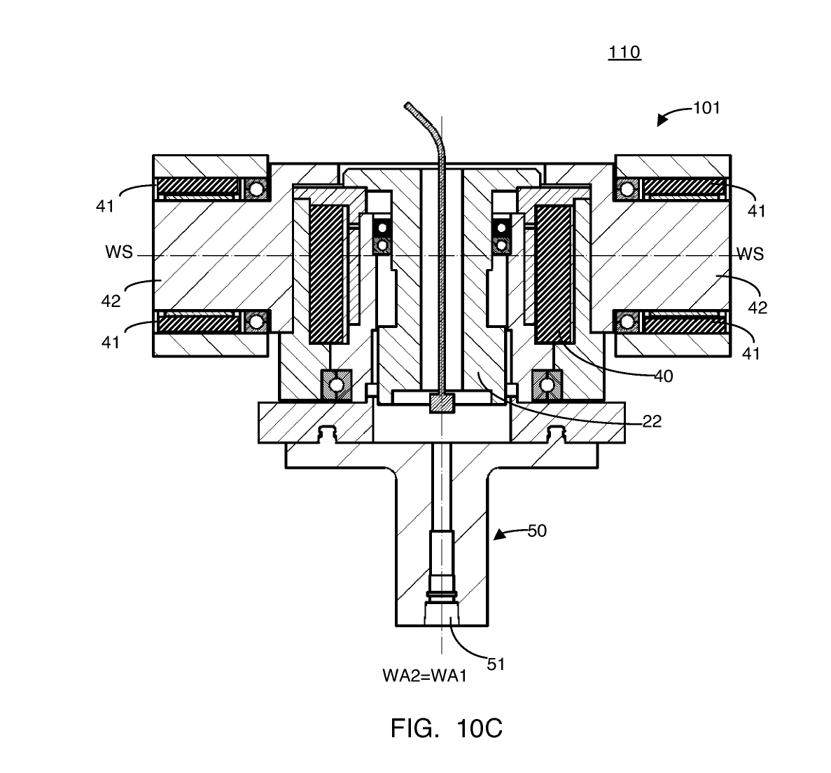

A further embodiment is shown in FIG. 10A. The elements are essentially the same again and are therefore not described once again. It is a tool head 110 having a fork head, the fork head having a pivot axis WS, around which the second element 102 can be tilted or pivoted. Two shaft stubs 42 of the second element 102 are seated in holes of the first element 101. For example, the windings and magnet (designated as a whole as 41) of two direct drives are situated in the area of the holes, which allow the pivot or tilting movement of the second element 102 around the pivot axis WS to be executed. The pivot axis WS is a so-called NC positioning axis, which is designed for the purpose of executing positioning movements before or during the processing of a workpiece.

FIG. 10B shows a sectional view of the tool head 110 according to FIG. 10A in a stretched position, the tool head 110 carrying a motor spindle 20. The motor spindle 20 in turn comprises a motor M1, as indicated in FIG. 10B, in order to allow the rotation of the tool 21 around the auxiliary axis R1. FIG. 10C shows a sectional view of the tool head 110 from FIG. 10A in a stretched position, the tool head 110 carrying a flange 50. The elements are essentially the same again and are therefore not described once again.

The change between milling tool 30 and motor spindle 20 can be performed automatically. In this case, the receptacle device 120 is designed for automated operation.

The first drive A1 and the receptacle device 120 are preferably dimensioned for torque forces which are greater than 1500 Nm, in order to be able to use the drive A1 as the drive of 30, for example, for bevel gear milling, in the first case.

The various embodiments may be readily combined with one another in order to allow further constellations.

The tool head 110 is used as an intelligent (electromechanical, hydraulic-mechanical, or pneumatic-mechanical) interface of the machine 100 and can make a multiaxis machine 100 more flexibly usable. By attaching the motor spindle 20 having integrated motor M1, the machine 100 is expandable by a further NC axis. An optimized specialized machine 100 (such as a bevel gear cutting machine) may thus become a universally usable processing center.

| | |
|---|---|
| adjustment movement | 11 |
| motor spindle | 20 |
| tool/milling cutter | 21 |
| shaft | 22 |
| power terminals | 23 |
| machine-side power terminals | 24 |
| milling tool | 30 |
| tool or processing side | 31 |
| spindle or shaft | 32 |
| energy supply | 33 |
| winding | 40 |
| direct drive | 41 |
| shaft stubs | 42 |
| flange | 50 |
| multiaxis machine | 100 |
| first element or first assembly | 101 |
| second element or second assembly | 102 |
| coupling | 103 |
| diagonal surfaces | 103.1, 103.2 |
| vertical surface or lateral surface | 104 |
| spindle body | 105 |
| drive connection | 106 |
| front side | 107 |
| tool head | 110 |
| transition area | 111 |
| connection means | 121 |
| NC-controller | 200 |
| control lines | 201 |
| (main) drive (machine-side) | A1 |
| arrow | P1 |
| auxiliary axis | R1 |
| rotational axis | R2 |
| motor | M1 |
| positioning drive | S1 |
| angle of inclination | W1 |
| angle | W |
| pivot axis | WS |
| tool axes | WA1, WA2 |

1. A tool head (110) for use in a multiaxis machine (100), wherein the tool head (110) comprises:
a spindle body (105), which comprises two elements (101, 102), which are rotatably connected to one another via a corresponding coupling (103), the first element (101) of the two elements (101, 102) having a first longitudinal axis (WA1) and the second element (102) of the two elements (101, 102) having a second longitudinal axis (WA2), which are transferable from a concentric position into an angled position depending on the rotational position,
a first drive (A1), which is seated in or on the spindle body (105),
a receptacle device (120), which is situated on the second element (102), this receptacle device (120)
being designed for fastening a motor spindle (20), a motor (M1), which is integrated in the motor spindle (20), being able to be supplied with energy via the second element (102) and connection means (121) of the receptacle device (120),
being designed for fastening a milling tool (30), the milling tool (30) being drivable using the first drive (A1).

2. Tool head (110) according to claim 1, characterized in that the corresponding coupling (103) is designed in the form of an articulated connection.

3. Tool head (110) according to claim 1, characterized in that the corresponding coupling (103) is implemented using two diagonal surfaces (103.1, 103.2), which are pivotable to one another.

4. Tool head (110) according to claim 1, characterized in that the first drive (A1) and the receptacle device (120) are dimensioned for torque forces which are greater than 1500 Nm.

5. Tool head (110) according to claim 2, characterized in that the articulated connection is implemented using a fork head, which allows a pivot or tilting movement around a pivot axis (WS).

6. Tool head (110) according to claim 1, characterized in that a control connection to an NC-controller (200) of the machine (100) is producible via the connection means (121).

7. Tool head (110) according to claim 1, characterized in that the receptacle device (120) comprises a power supply connection (121, 123), so that the motor (M1) of the motor spindle (20) can be supplied with power on the machine side through the second element (102).

8. Tool head (110) according to claim 1, characterized in that the receptacle device (120) comprises an energy supply connection, so that the motor (M1) of the motor spindle (20) can be supplied with hydraulic or pneumatic energy as the drive for the motor spindle (20) on the machine side through the second element (102).

9. A machine (100) for processing workpieces, characterized in that the machine (100) comprises:
multiple numerically controlled axes,
an NC-controller (200) for the controlled movement of the axes,
a tool head (110), which comprises a spindle body (105) having two elements (101, 102), which are rotatably connected to one another via a corresponding coupling (103), the first element (101) of the two elements (101, 102) having a first longitudinal axis (WA1) and the second element (102) of the two elements (101, 102) having a second longitudinal axis (WA2), which are transferable depending on the rotational position from a concentric position into an angled position,
a first drive (A1), which is seated in or on the spindle body (105),
a receptacle device (120), which is situated on the second element (102), this receptacle device (120)
being designed for fastening a motor spindle (20), a motor (M1), which is integrated in the motor spindle (20), being able to be supplied with energy from the machine (100) via the second element (102) and connection means (121) of the receptacle device (120),
being designed for fastening a milling tool (30), the milling tool (30) being drivable using the first drive (A1).

10. Machine (100) according to claim 9, characterized in that the machine (100) comprises at least one slide (11) or carriage, which allows a displacement of the tool head (110) in relation to a workpiece.

11. Machine (100) according to claim 9, characterized in that the machine (100) is expandable by a further axis by the attachment of the tool head (110) having the motor spindle (20) having the integrated motor (M1).

12. Machine (100) according to claim 9, characterized in that the corresponding coupling (103) is implemented as an articulated connection using a fork head, the fork head allowing a pivot or tilting movement around a pivot axis (WS).

13. A use of a machine (100) according to claim 9, characterized in that the following steps are executed:
attaching a milling tool (30) to the tool head (110),
activating a positioning drive (S1) of the tool head (110), in order to set the second element (102) in a desired angular position (W) in relation to the first element (101) using a positioning movement,
activating the first drive (A1) using an NC-controller (200) of the machine (100), in order to set the milling tool (30) into a rotational movement around the second longitudinal axis (WA2),
activating other axes of the machine (100) using the NC-controller (200), in order to execute a processing movement in relation to a workpiece.

14. Use of a machine (100) according to claim 13, characterized in that the following steps are executed:
removing the milling tool (30),
attaching a motor spindle (20) to the tool head (110), a connection being produced to the machine (100), in order to be able to supply the motor (M1), which is integrated in the motor spindle (20), with energy via the second element (102),
activating the positioning drive (S1) of the tool head (110), in order to set the second element (102) in a desired angular position (W) in relation to the first element (101) using a positioning movement,
activating the motor (M1), in order to set a milling cutter (21) of the motor spindle (20) into a rotational movement around an auxiliary axis (R1),
activating other axes of the machine (100) using the NC-controller (200), in order to execute a processing movement relative to a workpiece.

15. Use of a machine (100) according to claim 14, characterized in that a continuous change of the rotational angle (W) between the second element (102) and the motor spindle (20) is additionally performed using the positioning drive (S1).

16. Use of a machine (100) according to claim 13, characterized in that the milling tool (30) is used for the hard processing of a gearwheel, preferably a bevel gear.

17. Use of a machine (100) according to claim 14, characterized in that the milling cutter (21) of the motor spindle (20) is used for the green processing of a gearwheel, preferably a bevel gear.
